(19) United States
(12) Patent Application Publication
(10) Pub. No.: US 2018/0032936 A1
(43) Pub. Date: Feb. 1, 2018

(54) Product Shipment Facilitation Apparatus

(71) Applicant: Wal-Mart Stores, Inc., Bentonville, AR (US)

(72) Inventors: Chad Smithpeters, Anchorage, AK (US); Andrew B. Millhouse, Gilbert, AZ (US)

(21) Appl. No.: 15/663,279

(22) Filed: Jul. 28, 2017

Related U.S. Application Data
(60) Provisional application No. 62/367,811, filed on Jul. 28, 2016.

(51) Int. Cl. G06Q 10/06; G06Q 10/08; G06Q 30/02; G06Q 10/04

(52) U.S. Cl. CPC G06Q 10/06315; G06Q 10/047; G06Q 10/08; G06Q 30/0201

(57) ABSTRACT

A plurality of retail shopping facilities are operated by an enterprise within a first contiguous geographic region and at least one additional retail shopping facility is operated by the enterprise in a second geographic region that is non-contiguous with respect to the first contiguous geographic region. A control circuit facilitates shipment of products to the plurality of retail shopping facilities using a plurality of delivery vectors and also facilitates shipment of products to the at least one additional retail shopping facility using at least one additional delivery vector that is not part of the plurality of delivery vectors.

### CROSS-REFERENCE TO RELATED APPLICATION

This application claims the benefit of U.S. Provisional Application No. 62/367,811, filed Jul. 28, 2016, which is incorporated herein by reference in its entirety.

### TECHNICAL FIELD

These teachings relate generally to shipping vectors including cargo-conveying ships and also to communications network architectures.

### BACKGROUND

A geographically-distributed multi-store retail enterprise will often use a variety of different shipping vectors to move products from, for example, a distribution center or supplier to a given retail shopping facility. Examples in these regards often include truck-based shipping vectors and rail-based shipping vectors.

In some cases, however, the enterprise may operate some retail shopping facilities in a first contiguous geographic region (such as the so-called lower 48 states of the United States) and other retail shopping facilities in one or more other geographic regions that are non-contiguous with respect to the first contiguous geographic region (such as the states of Alaska and Hawaii). In such a case the enterprise may employ a shipping vector such as a cargo-conveying ship that can more readily or conveniently convey products from the first contiguous geographic region to the other geographic region(s) than, say, trucks or trains.

Unfortunately, the scheduling paradigms (and often even the physical aspects) of shipping via ocean-going vessels are typically very different from those which characterize a typical truck or train-based shipment. These differences can arise at least in part because of the often enormous differences between the shipping capacity of a ship and a truck or even a train. How shipments are scheduled and tracked, the loading and unloading of the ship, and even the retrieval of an emptied container are all often very different from trucking and train-based settings.

These differences, in turn, can and do lead to significant disconnects and shortfalls as regards the ability of a scheduling and tracking system to support both the needs of shipping within and external to a contiguous geographic region. In particular, a system well suited to handle such matters for trucks/trains is typically ill-suited to handle such matters for sea-going vessels and vice versa. As a result, managers within the enterprise and interested parties at the various shipping vectors are often without sufficient information and access capabilities to readily and effectively monitor and utilize the full panoply of shipping vectors employed by a given enterprise.

### BRIEF DESCRIPTION OF THE DRAWINGS

The above needs are at least partially met through provision of the product shipment facilitation apparatus described in the following detailed description, particularly when studied in conjunction with the drawings, wherein:

FIG. 1 comprises a block diagram as configured in accordance with various embodiments of these teachings; and

FIG. 2 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments presume a plurality of retail shopping facilities that are operated by an enterprise within a first contiguous geographic region and at least one additional retail shopping facility that is operated by the enterprise in a second geographic region that is non-contiguous with respect to the first contiguous geographic region. A control circuit, in turn, facilitates shipment of products to the plurality of retail shopping facilities using a plurality of delivery vectors and also facilitates shipment of products to the at least one additional retail shopping facility using at least one additional delivery vector that is not part of the plurality of delivery vectors.

By one approach the at least one additional delivery vector may serve to bridge a physical gap between the first contiguous geographic region and the second geographic region (such as an ocean). As one example in these regards the additional delivery vector may comprise a cargo-conveying ship (in particular, an ocean-going ship). (As used herein, an “ocean-going ship” will be understood to comprise a ship that is designed, rated, and approved for commercial use in trans-oceanic journeys as versus more limited uses on lakes, rivers, and smaller seas.)

By one approach the control circuit is configured to provide information regarding the shipment of products via a user interface to a community of users. Examples of the latter can include employees of the enterprise as well as agents associated with the additional delivery vector(s). The conveyed information can include, for example, scheduling information regarding the shipment of the products (including water-borne shipment of the products), a bill of lading for a water-borne shipment of products, and scheduling information for follow-on (i.e., post ship) land-based shipment of the products within the second geographic region.

These teachings are highly flexible in practice. For example, when shipping containers are used to ship products by sea, these teachings will accommodate providing information via the aforementioned user interface regarding availability of the shipping container(s) to be retrieved post-delivery and hence returned.

So configured, a single user-interface and service platform can more than suffice to allow various users (both within and external to a particular retail enterprise) to access and schedule various and all activities pertaining to shipping both within and external to a contiguous geographic area. In particular, these teachings will readily accommodate consolidating shipping information that includes delivery vectors that are not typically employed within the confines of that contiguous geographic area. These benefits are attained, in part, by improving the technological basis by which an existing computer-based platform is presently able to serve part, but not all, of these needs. For example, these teachings provide for leveraging (rather than replacing) existing database technologies beyond their ordinary design and delivery capabilities to accommodate shipping paradigms and characteristics that are not otherwise supported thereby.

These and other benefits may become clearer upon making a thorough review and study of the following detailed description.

As noted above, these teachings are applicable in an application setting where an enterprise operates a plurality of retail shopping facilities in a first contiguous geographic region and at least one additional retail shopping facility in a second geographic region that is non-contiguous with respect to the first contiguous geographic region. As used herein, a region is geographically contiguous when the whole of a geographic region (including both its land and water-covered terrain such as rivers and lakes) is within a single political national sovereignty. Accordingly, two regions are geographically non-contiguous when wholly separated by at least one of a non-national body of water (such as an ocean) and/or at least one national political boundary (such as a country border). (It will be further understood that so-called territorial waters are not considered to be a non-national body of water as used herein, and therefore an island located only five miles offshore of the lower 48 states cannot be considered to be non-contiguous with the lower 48 states.)

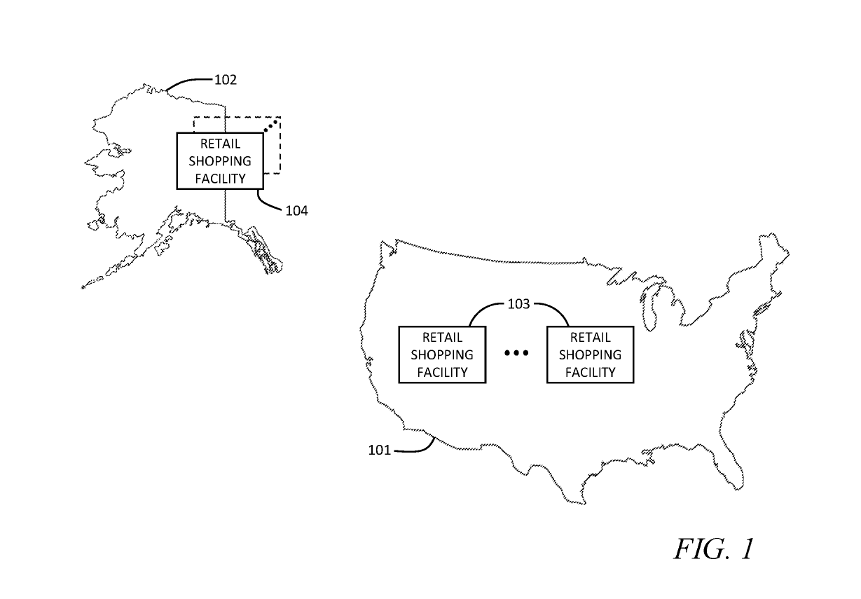

FIG. 1 provides an illustrative example in these regards. In this example the lower 48 states 101 of the United States constitute a contiguous geographic region per the foregoing definition (where the single political national sovereignty is the United States of America). The state of Alaska 102, on the other hand, is separated from the lower 48 states 101 by ocean waters and by terrain (not shown) that is a part of Canada and hence within a different political national sovereignty. Accordingly, the state of Alaska 102 is a geographic region that is non-contiguous with respect to the lower 48 states 101. As another example, the state of Hawaii (not shown) is separated from the lower 48 states 101 by a vast distance of ocean waters and hence also constitutes a geographic region that is non-contiguous with respect to the lower 48 states 101.

Accordingly, and as an illustrative example, a retail shopping facility in Alaska is fully separated from the lower 48 states by a national political boundary (i.e., the national border between Canada and the United States of America) while a retail shopping facility in Hawaii is fully separated from the lower 48 states by considerable ocean waters. In this simple example these two retail shopping facilities are in geographic regions that are non-contiguous with respect to one another as well.

For the sake of an illustrative example, and without intending any particular limitations by way of the specificity of this example, it will be presumed herein for the remainder of this description that the aforementioned enterprise operates a plurality of retail shopping facilities 103 in the lower 48 states 101 (i.e., a first contiguous geographic area) and at least one additional retail shopping facility 104 in Alaska 102 (i.e., a geographic region that is non-contiguous with respect to the lower 48 states 101).

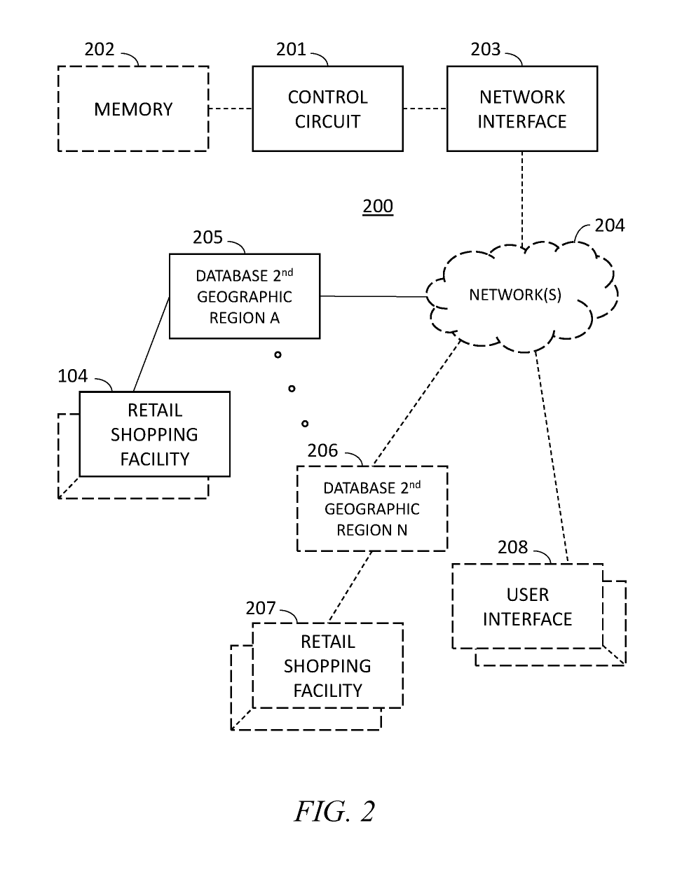

FIG. 2 presents an enabling apparatus 200 that includes a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to an optional memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to information that corresponds to the activities described herein, this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 also operably couples to a network interface 203. So configured the control circuit 201 can communicate with other elements (both within the apparatus 200 and external thereto) via the network interface 203. Network interfaces, including both wireless and non-wireless platforms, are well understood in the art and require no particular elaboration here. This network interface 201 communicatively couples to one or more wireless and/or non-wireless networks 204 including but not limited to the Internet.

In this example each of the retail shopping facilities 104 in Alaska 102 couples to a corresponding database 205 that consolidates the relevant data for that geographic region. If desired this database 205 could cover only a part of a single contiguous region (such as only a part of Alaska 102) or may cover more than one isolated region (such as, for example, both Alaska and Hawaii). In this example the database 205 covers retail shopping facilities 104 for all of Alaska and only Alaska.

As one specific but non-limiting example in these regards, each retail shopping facility 104 within Alaska 102 maintains its own Excel-based spreadsheet for that facility's relevant shipping information. The aforementioned database 205, in turn, can comprise an Access database that receives on some automated or semi-automated basis part or all of the information in the aforementioned Excel-based spreadsheets. So configured, this database 205 can aggregate as desired the shipping-relevant information for all of the retail shopping facilities 104 within this other geographic region that is non-contiguous with respect to the lower 48 states 101.

The control circuit 201 can interact with this database 205 to carry out a variety of useful capabilities. For example, the control circuit 201 can be configured to facilitate the shipment of products to retail shopping facilities 103 within the lower 48 states 101 using a plurality of delivery vectors and to also facilitate the shipment of products to the additional retail shopping facility(s) 104 in Alaska using at least one additional delivery vector that is not a part of the aforementioned plurality of delivery vectors that are employed in the lower 48 states 101. (As used herein, the expression “delivery vector” will be understood to refer to a particular modality of physically shipping a product to a retail shopping facility. Examples include but are not limited to semi-trailers and their corresponding trucks, panel trucks, flat-bed trucks, railroad cars, and boats/barges/ships.)

Generally speaking, the aforementioned additional delivery vector comprises a shipping paradigm that is configured and authorized to bridge a physical gap (such as a significant body of water) between the second geographic region (Alaska in this example) and the first contiguous geographic region (the lower 48 states in this example). The aforementioned additional delivery vector can accordingly comprise, for example, a cargo-conveying ship that is configured and authorized to convey cargo across the ocean water between the lower 48 states 101 and Alaska 102 (by, for example, conveying products from the lower 48 states to retail shopping facilities 104 in Alaska 102).

By one approach, the control circuit 201 can be programmed using QuickBase to help carry out the aforementioned capabilities. QuickBase is a Web-based project management solution that permits users to collaborate with team members, clients, associates, and vendors. This program will accommodate custom roles and permissions, such that some users can see and work with limited data while others can see it all. So configured, the control circuit 201 will readily enable workflow automation by utilizing forms, alerts, reminders, and notifications while also allowing users to create personalized to-do lists, highlight assigned tasks, and be notified of deadlines and project status. QuickBase is compatible with the aforementioned Excel-based spreadsheets and Access database and will also accommodate the creation and use of customizable apps and dashboards.

As suggested in FIG. 2, these teachings will readily accommodate additional databases 206 serving additional retail shopping facilities 207 in other geographic regions (for example, Hawaii) that are also non-contiguous with the first contiguous geographic region (i.e., the lower 48 states 101 in the present example). These additional databases 206 can be essentially the same as the above-described database 205 and can communicate and interact with their respective retail shopping facilities 207 in the same manner.

Also as suggested in FIG. 2, one or more user interfaces 208 can couple via the network 204 to the control circuit 201 to permit a variety of users to access the aggregated shipping information available thereat. These user interfaces 208 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

So configured, information regarding the shipment of products to retail shopping facilities 204, 207 in geographic regions that are non-contiguous with a main geographic region serviced by the enterprise using the aforementioned additional delivery vector(s) can be readily input and/or viewed by a community of users. This community of users can vary with the needs of the application setting but can include, for example, employees (and/or contractors) of the enterprise as well as agents associated with the at least one additional delivery vector. Examples in the latter regard include employees and contractors of a water-borne shipping line that operates ocean-going cargo-conveying ships to transport products from the contiguous geographic region to one of the non-contiguous geographic areas.

These teachings are highly flexible in practice and will accommodate a variety of modifications and approaches. By one approach, for example, information available amongst the community of users can include scheduling information regarding the shipment of products including scheduling information regarding water-borne shipment of products via an ocean-going cargo-conveying ship. Such scheduling information can include departure and arrival dates, ports of departure and ports of arrival, and so forth. As another example, the available information can comprise, at least in part, a bill of lading for the water-borne shipment of products.

Generally speaking, a retail shopping facility will not be located literally at the dock where a ship unloads its cargo. Accordingly, it will typically be necessary or at least useful to utilize land-based shipping modalities within the aforementioned non-contiguous geographic region to transport products from a ship to one or more destination retail shopping facilities. With that in mind that teachings will also accommodate making scheduling information regarding such land-based shipments available via the control circuit 201 to the relevant community of users.

By one approach these teachings will also readily address one particularly nettlesome problem that arises when shipping items via container ships. Container ships are cargo ships that carry their load in a plurality of truck-size intermodal containers. This transport modality is highly popular and presently carries most seagoing non-bulk cargo. The containers themselves are typically either 20-foot long or 40-foot long International Organization for Standardization (ISO)-standard containers. These containers can be loaded with items to be shipped and then themselves loaded onto the container ship. Upon reaching the ship's land destination, the containers can then be offloaded and transported (for example, by truck or rail) to a land destination where the container is then opened. The above-mentioned problem that arises in these regards is returning the emptied container.

Per these teachings the control circuit 201 can provide information to a relevant community of users via the user interface 208 regarding availability of a shipping container to be retrieved from a retail shopping facility 104 post-delivery and returned for reuse. The relevant community of users can vary with the application setting but can, for example, include employees of the enterprise as well as agents associated with a delivery vector that has responsibility for retrieving the emptied container from the retail shopping facility 104.

For example, upon emptying a delivered container, an employee of a retail shopping facility 104 in Alaska 102 an make an entry using a local Excel spreadsheet to indicate the empty status of the container and/or its current availability to be picked up. That information can migrate to the aforementioned database 205 and then to the control circuit 201 where the container release information is made available via the user interface 208 using any of a variety of dashboard updates, alerts, pushed messages, and so forth as desired. The responsible party can then use that container release information to further schedule the retrieval of that container.

These teachings will readily accommodate having the container release information comprise user-interactive container release information. For example, in addition to permitting a store employee to make an entry indicating the availability of the container, the control circuit 201 can also be configured to accept one or more entries by, for example, an agent of the entity that is charged with picking up the container. Such an entry might comprise, for example, a scheduled day and time when the entity plans to visit the retail shopping facility and retrieve the emptied container.

Other examples of shipping-related content that could be shared and/or interacted with include, but are not limited to, information regarding on-hand adjustments, rail-based shipments, shipments of special classes of inventory (such as fresh produce and meats), backloaded containers, sailing schedules, port information (including docking schedules and availability), dispatching functionality, product returns, a must-arrive-by-date (MABD) calculator, container management logistics, and so forth.

So configured, these teachings permit an already-fielded network of local databases to not only be leveraged on behalf of a larger audience but to permit a unique community of users that includes ocean-going cargo carriers to interact in various ways regarding delivery vectors that range between non-contiguous geographic regions without requiring a complete overhaul and/or platform replacements throughout that existing network of local databases.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a plurality of retail shopping facilities operated by an enterprise in a first contiguous geographic region;
at least one additional retail shopping facility operated by the enterprise in a second geographic region that is non-contiguous with respect to the first contiguous geographic region;
a control circuit configured to:
facilitate shipment of products to the plurality of retail shopping facilities using a plurality of delivery vectors; and
facilitate shipment of products to the at least one additional retail shopping facility using at least one additional delivery vector that is not a part of the plurality of delivery vectors.

2. The apparatus of claim 1 wherein the second geographic region is fully separated from the first contiguous geographic region by at least one national political boundary.

3. The apparatus of claim 1 wherein the second geographic region is fully separated from the first contiguous geographic region by ocean waters.

4. The apparatus of claim 1 wherein the at least one additional retail shopping facility comprises at least two additional retail shopping facilities, wherein a first one of the additional retail shopping facilities is fully separated from the first contiguous geographic region by at least one national political boundary and a second one of the additional retail shopping facilities is fully separated from the first contiguous geographic region by ocean waters, and wherein the first and second additional retail shopping facilities are also non-contiguous with respect to one another.

5. The apparatus of claim 1 wherein the at least one additional delivery vector comprises a shipping paradigm that bridges a physical gap between the second geographic region and the first contiguous geographic region.

6. The apparatus of claim 5 wherein the at least one additional delivery vector comprises a cargo-conveying ship that conveys the products to be shipped to the at least one additional retail shopping facility.

7. The apparatus of claim 6 wherein the cargo-conveying ship conveys the products to be shipped to the at least one additional retail shopping facility from the first contiguous geographic region.

8. The apparatus of claim 1 wherein the control circuit is configured to facilitate the shipment of the products to the at least one additional retail shopping facility using at least one additional delivery vector that is not a part of the plurality of delivery vectors by, at least in part, providing information regarding the shipment of the products via a user interface to a community of users.

9. The apparatus of claim 8 wherein the community of users include employees of the enterprise and agents associated with the at least one additional delivery vector.

10. The apparatus of claim 9 wherein the information comprises, at least in part, scheduling information regarding the shipment of the products.

11. The apparatus of claim 10 wherein the scheduling information comprises scheduling information for water-borne shipment of the products.

12. The apparatus of claim 11 wherein the information regarding the shipment of the products comprises, at least in part, a bill of lading for the water-borne shipment of the products.

13. The apparatus of claim 11 wherein the scheduling information further comprises scheduling information for land-based shipment of the products within the second geographic region.

14. The apparatus of claim 1 wherein at least some of the products that are shipped to the at least one additional retail shopping facility are shipped using at least one shipping container.

15. The apparatus of claim 14 wherein the at least one additional delivery vector comprises a cargo-conveying ship.

16. The apparatus of claim 15 wherein the control circuit is further configured to:
provide information via a user interface to a community of users regarding availability of the at least one shipping container to be retrieved post-delivery and returned.

17. The apparatus of claim 16 wherein the community of users include employees of the enterprise and agents associated with the at least one additional delivery vector.

18. The apparatus of claim 17 wherein the information regarding availability of the at least one shipping container comprises container release information.

19. The apparatus of claim 18 wherein the container release information comprises user-interactive container release information.
